(19) United States
(12) Patent Application Publication
(10) Pub. No.: US 2013/0163074 A1
(43) Pub. Date: Jun. 27, 2013

(54) CONDUCTIVE FILM AND METHOD FOR MANUFACTURING THE SAME

(71) Applicants: Kyu Sang Lee, Gyunggi-do (KR); Young Woo Lee, Gyunggi-do (KR); Jung Ryoul Yim, Gyunggi-do (KR); Jae Hun Kim, Gyunggi-do (KR); Seul Gi Kim, Gyunggi-do (KR); Choong Hee Lee, Gyunggi-do (KR); Jin Uk Lee, Gyunggi-do (KR)

(72) Inventors: Kyu Sang Lee, Gyunggi-do (KR); Young Woo Lee, Gyunggi-do (KR); Jung Ryoul Yim, Gyunggi-do (KR); Jae Hun Kim, Gyunggi-do (KR); Seul Gi Kim, Gyunggi-do (KR); Choong Hee Lee, Gyunggi-do (KR); Jin Uk Lee, Gyunggi-do (KR)

(73) Assignee: SAMSUNG ELECTRO-MECHANICS CO., LTD., Gyunggi-do (KR)

(21) Appl. No.: 13/483,516

(22) Filed: May 30, 2012

(30) Foreign Application Priority Data
Dec. 21, 2011 (KR) 1020110139092

(51) Int. Cl. G02B 5/22; B05D 5/06

(52) U.S. Cl. 359/359; 427/126.1

(57) ABSTRACT

Disclosed herein are a conductive film and a method for manufacturing the same. The conductive film includes: electrode layers each formed on both surfaces of a transparent substrate by exposing/developing a silver salt emulsion layer and containing silver; and optical filter layers formed between both surfaces of the transparent substrate and the electrode layers or between one surface of the transparent substrate and the electrode layer to selectively block light. The optical filter layer is used, thereby making it possible to prevent exposure of the silver salt emulsion layers formed on both surfaces of the transparent substrate from affecting the silver salt emulsion layers formed on surfaces opposite to each other.

### CROSS REFERENCE TO RELATED APPLICATION

This application claims the benefit of Korean Patent Application No. 10-2011-0139092, filed on Dec. 21, 2011, entitled “Conductive Film and Method for Manufacturing The Same”, which is hereby incorporated by reference in its entirety into this application.

### BACKGROUND OF THE INVENTION

1. Technical Field

The present invention relates to a conductive film and a method for manufacturing the same.

2. Description of the Related Art

In accordance with the recent rapid advance of technologies such as a touch panel, static electricity prevention, an electromagnetic wave absorber, an electromagnetic wave shielding material, a photoelectrochemical cell, an electrochromic device (ECD) film and sheet, cable shielding, a light emitting diode (LED) film, a transparent conductive film and sheet, a field effect transistor (FET), a polymer dispersed liquid crystal display, and the like, utilization of a conductive film has significantly increased.

Particularly, as the rapid progress of an information-oriented society has been widening the use of computers more and more, the necessity for a touch panel that is simple, has minimum malfunction, and is capable of easily inputting information has increased. Therefore, the necessity of a conductive film used as a conductive film of the touch panel has also increased.

According to the prior art, a conductive film used as a conductive film of a touch panel has generally been formed of an indium tin oxide (ITO). However, the ITO has low electrical conductivity and is expensive since indium used as a raw material thereof is a rare earth metal. In addition, the indium is expected to be depleted within the next decade, such that it may not be smoothly supplied. In addition, an electrode layer formed of ITO has low durability since brittle fracture is easily generated therein.

Due to the above-mentioned reason, as disclosed in Korean Patent Laid-Open Publication No. 10-2010-0091497, research into a technology of forming a conductive film (a conductive film of a touch panel) using an opaque metal has been actively conducted. However, a method of forming a conductive film that has enough electrical conductivity and durability in spite of using a metal to thereby be commercialized has not been developed up to now.

### SUMMARY OF THE INVENTION

The present invention has been made in an effort to provide a conductive film having excellent electrical conductivity while replacing ITO by exposing/developing a silver salt emulsion layer to form an electrode layer containing silver.

According to a preferred embodiment of the present invention, there is provided a conductive film including: electrode layers each formed on both surfaces of a transparent substrate by exposing/developing a silver salt emulsion layer and containing silver; and optical filter layers formed between both surfaces of the transparent substrate and the electrode layers or between one surface of the transparent substrate and the electrode layer to selectively block light.

The silver salt emulsion layer may contain silver salts and binders.

The silver salt may be silver halide.

The electrode layer may have sheet resistance of 0.1 to 10 Ω/□.

The optical filter layer may block ultraviolet rays.

The optical filter layer may block an I-line, an H-line, or a G-line in ultraviolet rays.

The optical filter layer may be formed of a UV blocking inorganic material.

The optical filter layer may be formed of a UV organic material.

The conductive film may have transmissivity of 85% or more.

The conductive film may be a conductive film of a touch panel.

The electrode layer may have a thickness of 2 μm or less.

According to another preferred embodiment of the present invention, there is provided a method for manufacturing a conductive film, the method including: (A) forming optical filter layers selectively blocking light on one surface or both surfaces of a transparent substrate; (B) forming silver salt emulsion layers on the optical filter layer and the other surface of the transparent substrate in the case in which the optical filter layer is formed on one surface of the transparent substrate and forming the silver salt emulsion layers on the optical filter layers in the case in which the optical filter layers are formed on both surfaces of the transparent substrate; and (C) forming electrode layers containing silver by exposing/developing the silver salt emulsion layers.

In step (B), the silver salt emulsion layer may contain silver salts and binders.

The silver salt may be silver halide.

In step (C), the electrode layer may have sheet resistance of 0.1 to 10 Ω/□.

In step (A), the optical filter layer may block ultraviolet rays.

In step (A), the optical filter layer may block an I-line, an H-line, or a G-line in ultraviolet rays.

In step (A), the optical filter layer may be formed of a UV blocking inorganic material.

In step (A), the optical filter layer may be formed of a UV blocking organic material.

In step (C), the silver salt emulsion layer may be exposed using a proximity exposure device or a contact exposure device.

The conductive film may be a conductive film of a touch panel.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are cross-sectional views of a conductive film according to a preferred embodiment of the present invention; and

FIGS. 2 to 6 are cross-sectional views showing a method for manufacturing a conductive film according to a preferred embodiment of the present invention according to a process order.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

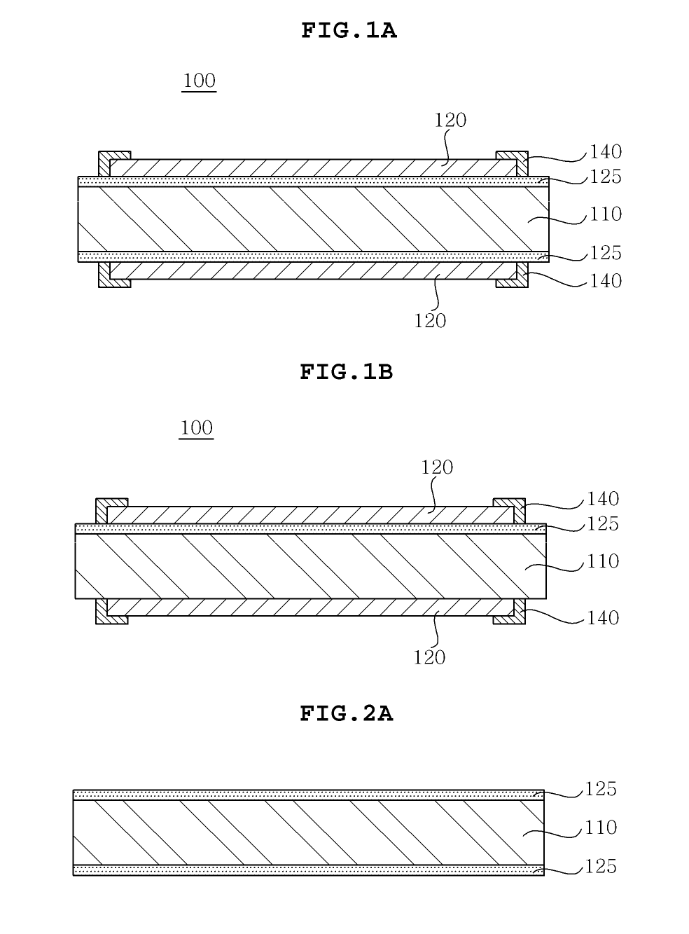

FIGS. 1A and 1B are cross-sectional views of a conductive film according to a preferred embodiment of the present invention.

As shown in FIGS. 1A and 1B, the conductive film 100 according to the present embodiment is configured to include electrode layers 120 each formed on both surfaces of a transparent substrate 110 by exposing/developing a silver salt emulsion layer 130 and containing silver and optical filter layers (or an optical filter layer) 125 formed between both surfaces of the transparent substrate 110 and the electrode layers 120 or between one surface of the transparent substrate 110 and the electrode layer 120 to selectively block light.

The transparent substrate 110 serves to provide a region on which the electrode layers 120 are to be formed. Here, the transparent substrate 110 needs to have support force capable of support the electrode layers 120 and also needs to have transparency in the case in which it is used in a touch panel, a display, or the like. In consideration of the support force and the transparency described above, the transparent substrate 110 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, tempered glass, or the like, but is not necessarily limited thereto.

The electrode layer 120, which has electrical conductivity, serves to generate a signal at the time of touch thereof in the case in which it is used in the touch panel, thereby allowing a controller to recognize a touch coordinate. Here, the electrode layers 120 are formed on both surfaces of the transparent substrate 110 and contain silver formed by exposing/developing the silver salt emulsion layer 130 as shown in FIG. 3A or 3B.

Here, the silver salt emulsion layer 130 may contain silver salts 133 and binders 135. More specifically, the silver salt 133 may be an inorganic silver salt such as silver halide (AgCl, AgBr, AgF, and Agl), or the like, or an organic silver salt such as acetic acid silver, or the like. In addition, the binder 135, which uniformly disperses the silver salts 133 and enhances adhesion between the silver salt emulsion layer 130 and the optical filter layer 125 or between the silver salt emulsion layer 130 and the transparent substrate 110, may be gelatin, polyvinyl alcohol (PVA), polyvinyl pyrrolidone (PVP), polysaccharide such as starch, or the like, cellulose and a derivative thereof, polyethylene oxide, polyvinyl amine, chitosan, polylysine, poly acrylic acid, poly alginic acid, poly hyaluronic acid, carboxymethyl cellulose, or the like. This binder 135 has a natural property, an anionic property, or a cationic property according to ionicity of a functional group.

In addition, the sliver salt emulsion layer 130 may further contain an additive such as a solvent, a dye, or the like, in addition to the silver salt 133 and the binder 135. More specifically, the solvent may be water, an organic solvent (for example, alcohols such as methanol, or the like, ketones such as acetone, or the like, amides such as formamide, sulfoxides such as dimethyl sulfoxide, or the like, esters such as ethyl acetate, or the like, ethers, or the like), ionic liquid, and a mixture thereof.

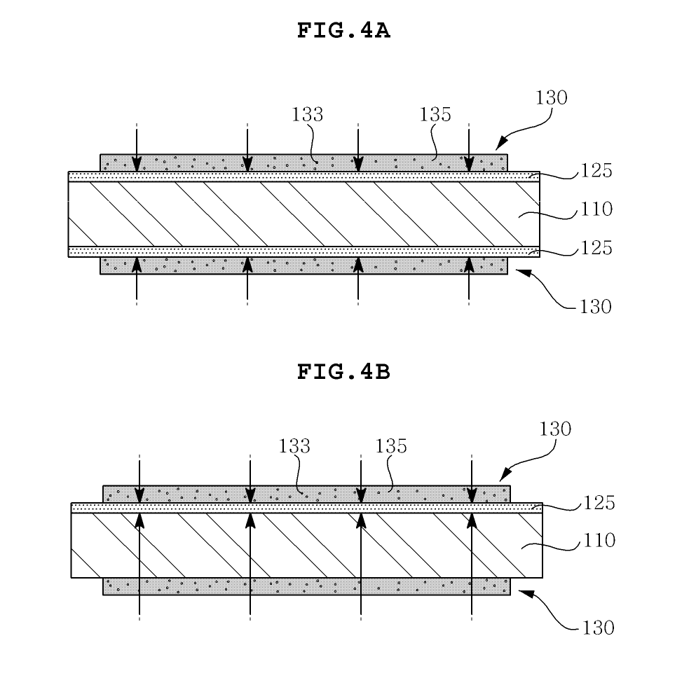

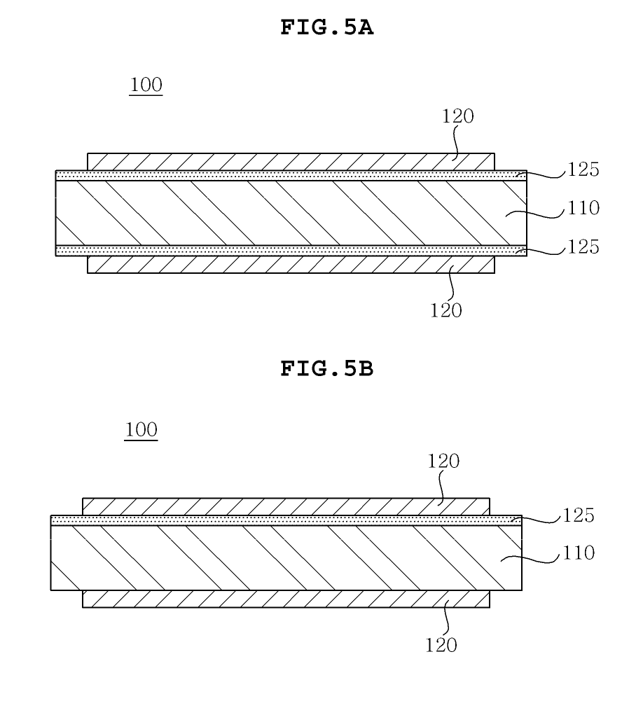

In addition, the electrode layer 120 is formed by exposing/developing the silver salt emulsion layer 130 (See FIGS. 4 and 5). When the silver salt emulsion layer 130 is exposed, a proximity exposure device or a contact exposure device may be used, which will be described in detail below in a method for manufacturing a conductive film.

Meanwhile, sheet resistance of the electrode layer 120 shown in FIG. 1A or 1B is not particularly limited, but may be 0.1 to 10 Ω/□. Here, the reason why the sheet resistance of the electrode layer 120 is set to be 0.1 to 10 Ω/□ is that when the sheet resistance of the electrode layer 120 is set to be 0.1 Ω/□ or less, an amount of sliver salt 133 significantly increases, such that transparency may be deteriorated, and when the sheet resistance of the electrode layer 120 is set to be 10 Ω/□ or more, electrical conductivity is low, such that utilization of the conducive film 100 decreases.

In addition, a thickness of the electrode layer 120 is not particularly limited, but may be 10 μm or less in order to secure appropriate transmissivity. The case in which a thickness of the electrode layer 120 is 2 μm or less is more advantageous to secure appropriate transmissivity.

The optical filter layer 125 serves to selectively block (reflect or absorb) the light to prevent exposure of the silver salt emulsion layers 130 formed on both surfaces of the transparent substrate 110 from affecting the silver salt emulsion layers 130 formed on surfaces opposite to each other. Here, the optical filter layers (or the optical filter layer) 125 are (is) formed between both surfaces of the transparent substrate 110 and the electrode layers 120 (See FIG. 1A) or between one surface of the transparent substrate 110 and the electrode layer 120 (See FIG. 1B). That is, the optical filter layers (or the optical filter layer) 125 are (is) formed at both sides of the transparent substrate 110 or at one side thereof.

More specifically, the optical filter layer 125 selectively blocks the light irradiated when the silver salt layer 130 is exposed (See FIG. 4A or 4B). Therefore, the light blocked by the optical filter layer 125 is determined in consideration of the light irradiated at the time of the exposure. Here, the light irradiated at the time of the exposure may be all wavelengths of light such as visible ray, ultraviolet ray, X-ray, and the like. When the ultraviolet ray (having a wavelength of about 10 to 397 nm) is irradiated at the time of the exposure, the optical filter layer 125 may be formed to selectively block the ultraviolet ray. More specifically, when an I-line (365 nm), an H-line (405 nm), or a G-line (436 nm) among ultraviolet rays is irradiated at the time of the exposure, the optical filter layer 125 is formed to selectively block only the I-line, the H-line, or the G-line. As described above, the optical filter layer 125 selectively blocks the light irradiated at the time of the exposure, thereby making it possible to prevent the light irradiated at the time of the exposure from affecting the silver salt layers 130 formed on the surfaces opposite to each other. In addition, since the optical filter layer 125 passes through most of light except for the light irradiated at the time of the exposure, the optical filter layer 125 may have substantially transparency.

Meanwhile, the optical filter layer 125 may be formed of a UV blocking inorganic material or a UV blocking organic material. Here, the UV blocking inorganic material may be a metal oxide such as indium tin oxide, titanium dioxide, or the like, and the UV blocking organic material may be benzophenone, benzotriazole, salicylic acid, acrylonitrile, an organic nickel compound, or the like. However, the above-mentioned materials are only an example, and the scope of the present invention is not limited thereto.

Additionally, in the case in which the conductive film 100 is used in the touch panel, an edge of the electrode layer 120 may be formed with wirings 140 receiving an electrical signal from the electrode layer 120. Here, the wiring 140 may be formed by screen printing, gravure printing, inkjet printing, or the like. In addition, as a material of the wiring 140, a material including silver (Ag) paste or organic silver that has excellent electrical conductivity may be used. However, the material of the wiring 140 is not limited thereto, but may be a conductive polymer, a carbonblack (including CNT), a metal oxide, metals, or the like.

Meanwhile, as described above, the conductive film 100 including the transparent substrate 110, the electrode layer 120, and the optical filter layer 125 may have transmissivity of 85% or more.

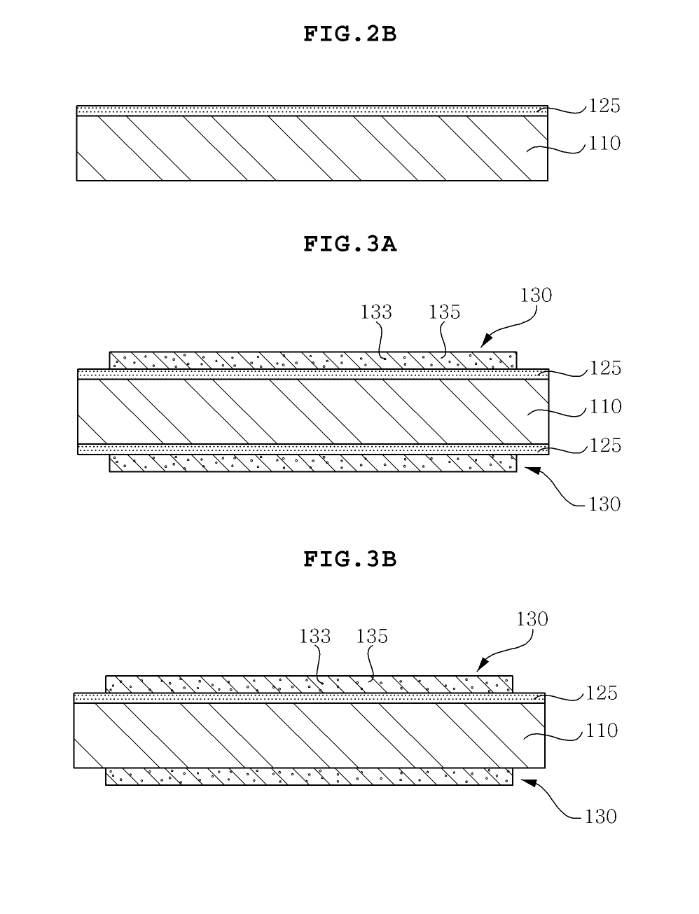

FIGS. 2 to 6 are cross-sectional views showing a method for manufacturing a conductive film according to a preferred embodiment of the present invention according to a process order.

As shown in FIGS. 2 to 6, the method for manufacturing a conductive film 100 according to the present embodiment includes (A) forming an optical filter layer (or optical filter layers) 125 selectively blocking light on one surface or both surfaces of a transparent substrate 110, (B) forming silver salt emulsion layers 130 on the optical filter layer 125 and the other surface of the transparent substrate 110 in the case in which the optical filter layer 125 is formed on one surface of the transparent substrate 110 and forming the silver salt emulsion layers 130 on the optical filter layers 125 in the case in which the optical filter layers 125 are formed on both surfaces of the transparent substrate 110, and (C) forming electrode layers 120 containing silver by exposing/developing the silver salt emulsion layers 130.

First, as shown in FIGS. 2A or 2B, the optical filter layer 125 is formed on the transparent layer 110. Here, the optical filter layer 125 serves to selectively block light at the time of exposure of the silver salt emulsion layers 130 in an operation to be described below to prevent the light from affecting the silver salt emulsion layers 130 formed on surfaces opposite to each other. Therefore, the optical filter layer 125 determines the light to be blocked in consideration of the light used at the time of the exposure. The light irradiated at the time of the exposure may be all wavelengths of light such as visible ray, ultraviolet ray, X-ray, and the like. When the ultraviolet ray (having a wavelength of about 10 to 397 nm) is irradiated at the time of the exposure, the optical filter layer 125 may be formed to selectively block the ultraviolet ray. More specifically, when an I-line (365 nm), an H-line (405 nm), or a G-line (436 nm) among ultraviolet rays is irradiated at the time of the exposure, the optical filter layer 125 is formed to selectively block only the I-line, the H-line, or the G-line.

As described above, the optical filter layer 125 may be formed of a UV blocking inorganic material or a UV blocking organic material in order to block the I-line, the H-line, or the G-line. More specifically, the UV blocking inorganic material may be a metal oxide such as indium tin oxide, titanium dioxide, or the like, and the UV blocking organic material may be benzophenone, benzotriazole, salicylic acid, acrylonitrile, an organic nickel compound, or the like. Meanwhile, in the case in which the UV blocking inorganic material is used as a material of the optical filter layer 125, the optical filter layer 125 may be formed by sputtering, evaporation, or the like. In addition, in the case in which the UV blocking organic material is used as a material of the optical filter layer 125, the optical filter layer 125 may be formed by die casting, screen printing, gravure printing, offset printing, bar coating, or the like.

Meanwhile, even in the case in which the optical filter layer 125 is formed only on one surface of the transparent 110, the optical filter layer 125 serves to selectively block the light at the time of the exposure of the silver salt emulsion layers 130 to prevent the light from affecting the silver salt emulsion layers 130 formed on the surfaces opposite to each other. Therefore, the optical filter layers 125 are not necessarily formed on both surfaces of the transparent substrate 110 as shown in FIG. 2A, but may also be formed only on one surface of the transparent substrate 110 as shown in FIG. 2B. Hereinafter, FIGS. 3A, 4A, 5A, and 6A show a configuration in which the optical filter layers 125 are formed on both surfaces of the transparent substrate 110, and FIGS. 3B, 4B, 5B, and 6B show a configuration in which the optical filter layer 125 is formed only on one surface of the transparent substrate 110.

Next, as shown in FIGS. 3A or 3B, the silver salt emulsion layer 130 is formed. In the above-mentioned operation, in the case in which the optical filter layers 125 are formed on both surfaces of the transparent substrate 110, the silver salt emulsion layers 130 are formed on the optical filter layers 125 (See FIG. 3A), and in the case in which the optical filter layer 125 is formed on one surface of the transparent substrate 110, the silver salt emulsion layers 130 are formed on the optical filter layer 125 and the other surface of the transparent substrate 110 (See FIG. 3B). Here, the silver salt layer 130 contains silver salts 133 and binders 135. More specifically, the silver salt 133 may be an inorganic silver salt such as silver halide (AgCl, AgBr, AgF, and AgI), or the like, or an organic silver salt such as acetic acid silver, or the like In addition, the binder 135 may be gelatin, polyvinyl alcohol (PVA), polyvinyl pyrrolidone (PVP), polysaccharide such as starch, or the like, cellulose to and a derivative thereof, polyethylene oxide, polyvinyl amine, chitosan, polylysine, poly acrylic acid, poly alginic acid, poly hyaluronic acid, carboxymethyl cellulose, or the like. For reference, the silver salt 133 is exaggerated in the accompanying drawings in order to assist in the understanding of the present invention. That is, a size, concentration, or the like, of the silver salt 133 shown in the accompanying drawings is not an actual size, concentration, or the like, thereof. In addition, the silver salt emulsion layer 130 may further contain an additive such as a solvent, a dye, or the like, in addition to the silver salt 133 and the binder 135.

Meanwhile, the silver salt emulsion layer 130 may be formed by die casting, screen printing, gravure printing, offset printing, bar coating.

Further, after the silver salt emulsion layer 130 is formed, it may be dried by a heat drying method, an infrared ray drying method, a natural drying method, or the like.

Then, as shown in FIGS. 4 and 5, the electrode layer 120 containing silver is formed by exposing/developing the silver salt emulsion layer 130.

More specifically, as shown in FIGS. 4A or 4B, the silver salt emulsion layer 130 is exposed. Since the silver salt emulsion layers 130 are formed at both sides of the transparent substrate 110 in the above-mentioned operation, exposure is performed at both sides of the transparent substrate 110 in the present operation. Here, the exposure is simultaneously performed at both sides of the transparent substrate 110 or is sequentially performed at each side thereof. Meanwhile, the light irradiated at the time of the exposure may be all wavelengths of light such as visible ray, ultraviolet ray, X-ray, and the like, and be generally the ultraviolet ray. More specifically, the exposure may be performed using the I-line (365 nm), the H-line (405 nm), or the G-line (436 nm) having large relative intensity at the time of high pressure mercury discharge. Among them, the I-line having a relative short wavelength may be selected in order to precisely perform the exposure.

When the light is irradiated to the silver salt emulsion layer 130 through the above-mentioned exposure, the silver salt 133 included in the silver salt emulsion layer 130 is photosensitized by optical energy, such that fine silver nucleous defined as a latent image is generated.

Meanwhile, as described above, even though the exposure is performed at both sides of the transparent substrate 110, since the optical filter layer 125 blocks the light irradiated at the time of the exposure (See an arrow), the silver salt emulsion layer is not affected by the light irradiated from an opposite surface of the transparent substrate 110.

In addition, when the silver salt emulsion layer 130 is exposed, a proximity exposure device or a contact exposure device may be used, wherein the contact exposure device has a relatively short tact time to improve productivity and be appropriate for mass production.

Thereafter, as shown in FIGS. 5A or 5B, the silver salt emulsion layer 130 is developed. In the present operation, a developer is supplied to the silver salt emulsion layer 130 to reduce metal silver. Here, silver ions provided from the silver salt 133 or the developer are reduced into the metal silver by a reducing agent in the developer using the silver nucleous as a catalyst. As described above, silver in the silver salt emulsion layer 130 is reduced, thereby making it possible to form the electrode layer 120 containing the silver.

Meanwhile, as a method of supplying a developer to the silver salt emulsion layer, all methods known in the art may be used. For example, the developer may be supplied to the silver salt emulsion layer 130 by a method of immersing the silver salt emulsion layer 130 in the developer, a method of spraying the developer to the silver salt emulsion layer 130, a method of allowing the developer in a steam form to contact the silver salt emulsion layer 130.

Additionally, after the silver salt layer 130 is developed, the silver salt layer 130 is cleaned using water or the developer is removed using high pressure air, and a fixing process of supplying a fixing solution to remove the silver salt 133 that is not reduced into the silver may be performed. Thereafter, the fixing solution is cleaned using water and then dried.

Surface resistance of the electrode layer 120 formed through the above-mentioned process is not particularly limited, but may be 0.1 to 10 Ω/□.

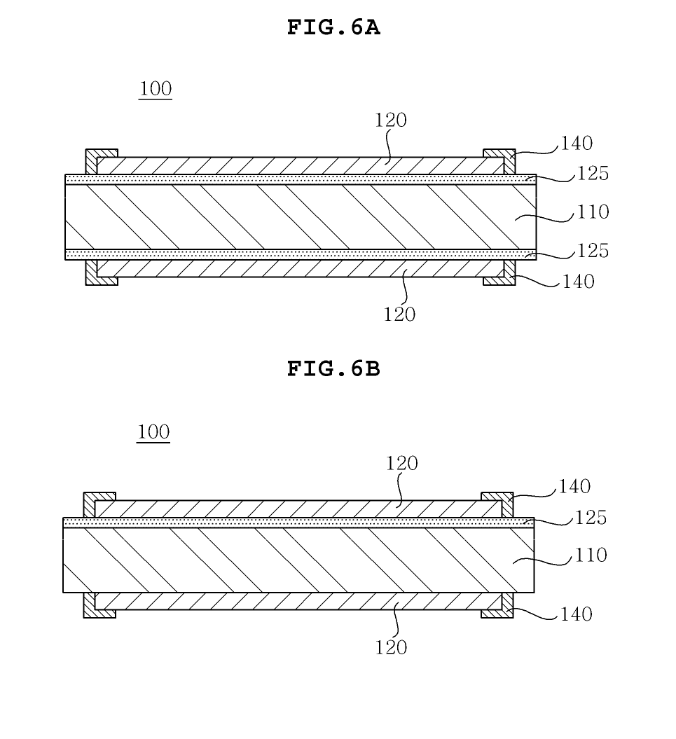

Next, as shown in FIGS. 6A and 6B, in the case in which the conductive film 100 is used in the touch panel, a wiring 140 may be formed at an edge of the electrode layer 120. Here, the wiring 140 which receives an electrical signal from the electrode layer 120 may be formed by screen printing, gravure printing, inkjet printing, or the like.

The conductive film 100 according to the preferred embodiment of the present invention may be used in a touch panel, static electricity prevention, an electromagnetic wave absorber, an electromagnetic shielding material, a photoelectrochemical cell, an electrochromic device (ECD) film and sheet, a cable shielding, a light-emitting diode (LED) film, a transparent conductive film and sheet, a field effect transistor (FET), a polymer dispersed liquid crystal (PDLC) display, or the like. However, the conductive film 100 is not necessarily limited to being used in the above-mentioned fields, but may be used in all fields in which a conductive film may be used.

As set forth above, according to the preferred embodiments of the present invention, the electrode layer containing the silver is formed by exposing/developing the silver salt emulsion layer, thereby making it possible to implement excellent electrical conductivity while replacing ITO and secure excellent durability since brittle fracture is not generated.

In addition, according to the preferred embodiments of the present invention, the optical filter layer is used, thereby making it possible to prevent exposure of the silver salt emulsion layers formed on both surfaces of the transparent substrate from affecting the silver salt emulsion layers formed on surfaces opposite to each other.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A conductive film comprising:
electrode layers each formed on both surfaces of a transparent substrate by exposing/developing a silver salt emulsion layer and containing silver; and
optical filter layers formed between both surfaces of the transparent substrate and the electrode layers or between one surface of the transparent substrate and the electrode layer to selectively block light.

2. The conductive film as set forth in claim 1, wherein the silver salt emulsion layer contains silver salts and binders.

3. The conductive film as set forth in claim 2, wherein the silver salt is silver halide.

4. The conductive film as set forth in claim 1, wherein the electrode layer has sheet resistance of 0.1 to 10 Ω/□.

5. The conductive film as set forth in claim 1, wherein the optical filter layer blocks ultraviolet rays.

6. The conductive film as set forth in claim 1, wherein the optical filter layer blocks an I-line, an H-line, or a G-line in ultraviolet rays.

7. The conductive film as set forth in claim 1, wherein the optical filter layer is formed of a UV blocking inorganic material.

8. The conductive film as set forth in claim 1, wherein the optical filter layer is formed of a UV blocking organic material.

9. The conductive film as set forth in claim 1, wherein it has transmissivity of 85% or more.

10. The conductive film as set forth in claim 1, wherein it is a conductive film of a touch panel.

11. The conductive film as set forth in claim 1, wherein the electrode layer has a thickness of 2 μm or less.

12. A method for manufacturing a conductive film, the method comprising:
(A) forming optical filter layers selectively blocking light on one surface or both surfaces of a transparent substrate;
(B) forming silver salt emulsion layers on the optical filter layer and the other surface of the transparent substrate in the case in which the optical filter layer is formed on one surface of the transparent substrate and forming the silver salt emulsion layers on the optical filter layers in the case in which the optical filter layers are formed on both surfaces of the transparent substrate; and
(C) forming electrode layers containing silver by exposing/developing the silver salt emulsion layers.

13. The method as set forth in claim 12, wherein in step (B), the silver salt emulsion layer contains silver salts and binders.

14. The method as set forth in claim 13, wherein the silver salt is silver halide.

15. The method as set forth in claim 12, wherein in step (C), the electrode layer has sheet resistance of 0.1 to 10 Ω/□.

16. The method as set forth in claim 12, wherein in step (A), the optical filter layer blocks ultraviolet rays.

17. The method as set forth in claim 12, wherein in step (A), the optical filter layer blocks an I-line, an H-line, or a G-line in ultraviolet rays.

18. The method as set forth in claim 12, wherein in step (A), the optical filter layer is formed of a UV blocking inorganic material.

19. The method as set forth in claim 12, wherein in step (A), the optical filter layer is formed of a UV blocking organic material.

20. The method as set forth in claim 12, wherein in step (C), the silver salt emulsion layer is exposed using a proximity exposure device or a contact exposure device.

21. The method as set forth in claim 12, wherein the conductive film is a conductive film of a touch panel.
